(19) United States
(12) Patent Application Publication
(10) Pub. No.: US 2018/0129409 A1
(43) Pub. Date: May 10, 2018

(54) METHOD FOR CONTROLLING EXECUTION OF APPLICATION ON ELECTRONIC DEVICE USING TOUCHSCREEN AND ELECTRONIC DEVICE FOR THE SAME

(71) Applicant: Samsung Electronics Co., Ltd., Suwon-si (KR)

(72) Inventors: Jung-Hwan LIM, Hwaseong-si (KR); Geon-Soo KIM, Suwon-si (KR); Kwang-Tai KIM, Yongin-si (KR); Dong-Hyun YEOM, Bucheon-si (KR); Ki-Huk LEE, Suwon-si (KR); Yo-Han LEE, Seongnam-si (KR); Yong-Joon JEON, Hwaseong-si (KR); Jae-Bong CHUN, Suwon-si (KR)

(21) Appl. No.: 15/805,816

(22) Filed: Nov. 7, 2017

(30) Foreign Application Priority Data
Nov. 7, 2016 (KR) 10-2016-0147745

(51) Int. Cl. G06F 3/0488; G06F 3/0482; G06F 3/0484

(52) U.S. Cl. CPC G06F 3/04883; G06F 3/04817; G06F 3/04845; G06F 3/0482

(57) ABSTRACT

Methods for controlling execution of an application on electronic devices using a touchscreen and electronic devices for implementing the same are provided. The method includes detecting a touch input on an icon area of the application displayed on the touchscreen, displaying at least one menu item corresponding to at least one function of the application based on a continuous touch input after detecting the touch input, and controlling the execution of the application based on the at least one menu item.

### CROSS-REFERENCE TO RELATED APPLICATION(S)

This application claims the benefit under 35 U.S.C. § 119(a) of a Korean patent application filed on Nov. 7, 2016 in the Korean Intellectual Property Office and assigned Serial number 10-2016-0147745, the entire disclosure of which is incorporated herein by reference.

### TECHNICAL FIELD

The present disclosure relates to methods for executing or launching applications on electronic devices using a touchscreen and electronic devices for implementing the same. More particularly, the present disclosure relates to a method for controlling quicker execution of an application, e.g., the length of a continuous touch input on a touchscreen-equipped electronic device.

### BACKGROUND

There is soaring use of electronic devices equipped with touch input-processable hardware, e.g., a touchscreen. Touchscreens can be implemented in at least one of capacitive, resistive, infrared (IR), and ultrasound types. An electronic device can determine coordinates of a touch input on the touchscreen. Touchscreens may be used in various types of electronic devices, for example, laptop computers, personal computers, or portable devices, such as smartphones or touchpads. A user may enter commands for running, e.g., an application, onto the touchscreen without an additional input device, e.g., a mouse.

Proliferating applications and their functions are prompting research efforts to achieve easier menu selection and quicker execution of applications on an electronic device.

To run a desired menu item on a menu screen provided by a gesture input on an icon of an application, an additional gesture, or a touch input, may be required. The additional gesture frequently requires several touch inputs.

Therefore, a need exists for a more comfortable manner for a touch input to execute an application on a touchscreen-equipped electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for controlling quicker execution of an application, e.g., the length of a continuous touch input on a touchscreen-equipped electronic device and an electronic device for implementing the same.

Another aspect of the present disclosure is to provide a method for reducing the number of touch inputs required to run or access an application on a touchscreen-equipped electronic device and an electronic device for implementing the same.

Another aspect of the present disclosure is to provide a method for executing, or accessing a function of, an application, e.g., the length of a continuous touch input on a touchscreen-equipped electronic device and an electronic device for implementing the same.

In accordance with an aspect of the present disclosure, a method for controlling execution of an application on an electronic device using a touchscreen is provided. The method includes detecting a touch input on an icon area of the application displayed on the touchscreen, displaying at least one menu item corresponding to at least one function of the application based on a continuous touch input after detecting the touch input, and controlling the execution of the application based on the at least one menu item.

In accordance with an aspect of the present disclosure, an electronic device using a touchscreen is provided. The electronic device includes a housing, a display panel including the touchscreen, a memory configured to store a program for controlling execution of an application, and at least one processor configured to control detecting of a touch input on an icon area of the application displayed on the touchscreen, control displaying of at least one menu item corresponding to at least one function of the application based on a continuous touch input after detecting the touch input, and control the execution of the application based on the at least one menu item.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, wherein:

FIG. 1A illustrates a network configuration including an electronic device according to an embodiment of the present disclosure;

FIG. 1B illustrates a configuration of an electronic device according to an embodiment of the present disclosure;

FIG. 1C illustrates a configuration of a program module according to an embodiment of the present disclosure;

FIGS. 2A, 2B, 2C, and 2D illustrate operations of controlling execution of an electronic device, e.g., a length of a touch input on the electronic device according to an embodiment of the present disclosure;

FIGS. 3A, 3B, and 3C illustrate operations of controlling execution of an electronic device, e.g., a length of a touch input on the electronic device according to an embodiment of the present disclosure;

FIGS. 4A, 4B, and 4C illustrate operations of controlling execution of an application(s) included in a folder, e.g., a length of a touch input on an electronic device according to an embodiment of the present disclosure;

FIGS. 5A and 5B illustrate operations of controlling execution of an application, e.g., a length and redirection of a touch input on an electronic device according to an embodiment of the present disclosure;

FIG. 6 illustrates a method for controlling execution of an electronic device, e.g., a length of a touch input on an electronic device according to an embodiment of the present disclosure;

FIG. 7 illustrates a method for controlling execution of an electronic device, e.g., a length of a touch input on an electronic device according to an embodiment of the present disclosure;

FIG. 8 illustrates a method for controlling execution of an electronic device, e.g., a length and direction of a touch input on an electronic device according to an embodiment of the present disclosure;

FIG. 9 illustrates a method for controlling execution of an electronic device, e.g., a length and time of a touch input on an electronic device according to an embodiment of the present disclosure; and

FIG. 10 illustrates a method for controlling execution of an electronic device, e.g., a length and speed of a touch input on an electronic device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural references unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As used herein, the terms “A or B” or “at least one of A and/or B” may include all possible combinations of A and B. As used herein, the terms “first” and “second” may modify various components regardless of importance and/or order and are used to distinguish a component from another without limiting the components. It will be understood that when an element (e.g., a first element) is referred to as being (operatively or communicatively) “coupled with/to,” or “connected with/to” another element (e.g., a second element), it can be coupled or connected with/to the other element directly or via a third element.

As used herein, the terms “configured to” may be interchangeably used with other terms, such as “suitable for,” “capable of,” “modified to,” “made to,” “adapted to,” “able to,” or “designed to” in hardware or software in the context. Rather, the term “configured to” may mean that a device can perform an operation together with another device or parts. For example, the term “processor configured (or set) to perform A, B, and C” may mean a generic-purpose processor (e.g., a central processing unit (CPU) or application processor (AP)) that may perform the operations by executing one or more software programs stored in a memory device or a dedicated processor (e.g., an embedded processor) for performing the operations.

For example, examples of the electronic device according to embodiments of the present disclosure may include at least one of a smartphone, a tablet personal computer (PC), a mobile phone, a video phone, an e-book reader, a desktop PC, a laptop computer, a netbook computer, a workstation, a server, a personal digital assistant (PDA), a portable multimedia player (PMP), a moving picture experts group (MPEG-1 or MPEG-2) audio layer 3 (MP3) player, a medical device, a camera, a wearable device, or the like. The wearable device may include at least one of an accessory-type device (e.g., a watch, a ring, a bracelet, an anklet, a necklace, glasses, contact lenses, a head-mounted device (HMD), or the like), a fabric- or clothes-integrated device (e.g., electronic clothes), a body attaching-type device (e.g., a skin pad or tattoo), a body implantable device, or the like. In an embodiment of the present disclosure, examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (e.g., Samsung HomeSync™⁺, Apple TV™, Google TV™, or the like), a gaming console (Xbox™, PlayStation™), an electronic dictionary, an electronic key, a camcorder, an electronic picture frame, or the like.

According to an embodiment of the present disclosure, the electronic device may include at least one of various medical devices (e.g., diverse portable medical measuring devices (a blood sugar measuring device, a heartbeat measuring device, a body temperature measuring device, or the like), a magnetic resource angiography (MRA) device, a magnetic resource imaging (MRI) device, a computed tomography (CT) device, an imaging device, an ultrasonic device, or the like), a navigation device, a global navigation satellite system (GNSS) receiver, an event data recorder (EDR), a flight data recorder (FDR), an automotive infotainment device, an sailing electronic device (e.g., a sailing navigation device or a gyro compass), avionics, security devices, vehicular head units, industrial or home robots, drones, automatic teller's machines (ATMs), point of sales (POS) devices, or internet of things (IoT) devices (e.g., a bulb, various sensors, a sprinkler, a fire alarm, a thermostat, a street light, a toaster, fitness equipment, a hot water tank, a heater, a boiler, or the like). According to various embodiments of the disclosure, examples of the electronic device may at least one of part of a piece of furniture, building/structure or vehicle, an electronic board, an electronic signature receiving device, a projector, or various measurement devices (e.g., devices for measuring water, electricity, gas, electromagnetic waves, or the like). According to embodiments of the present disclosure, the electronic device may be flexible or may be a combination of the above-enumerated electronic devices. According to an embodiment of the present disclosure, the electronic device is not limited to the above-listed embodiments. As used herein, the term “user” may denote a human or another device (e.g., an artificial intelligent electronic device) using the electronic device.

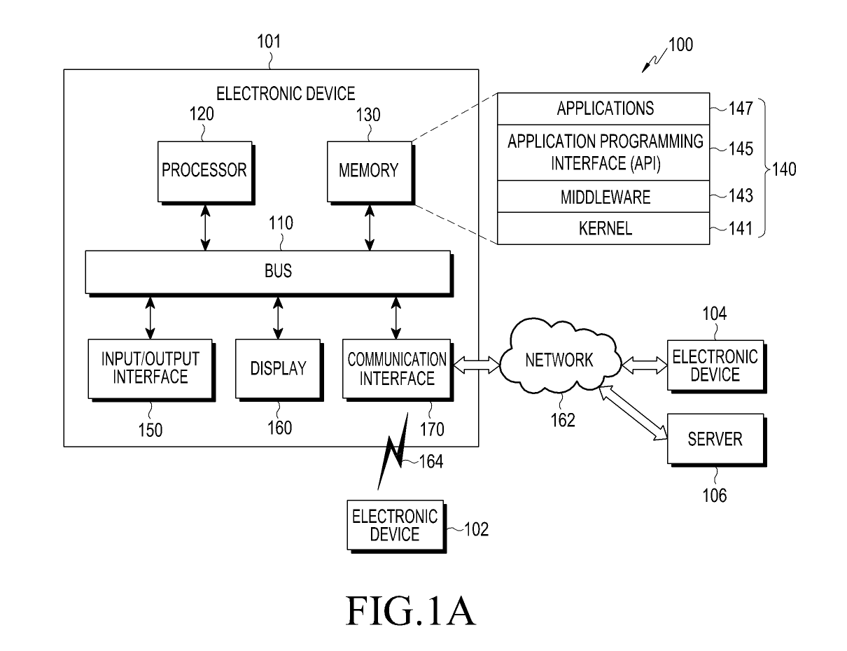

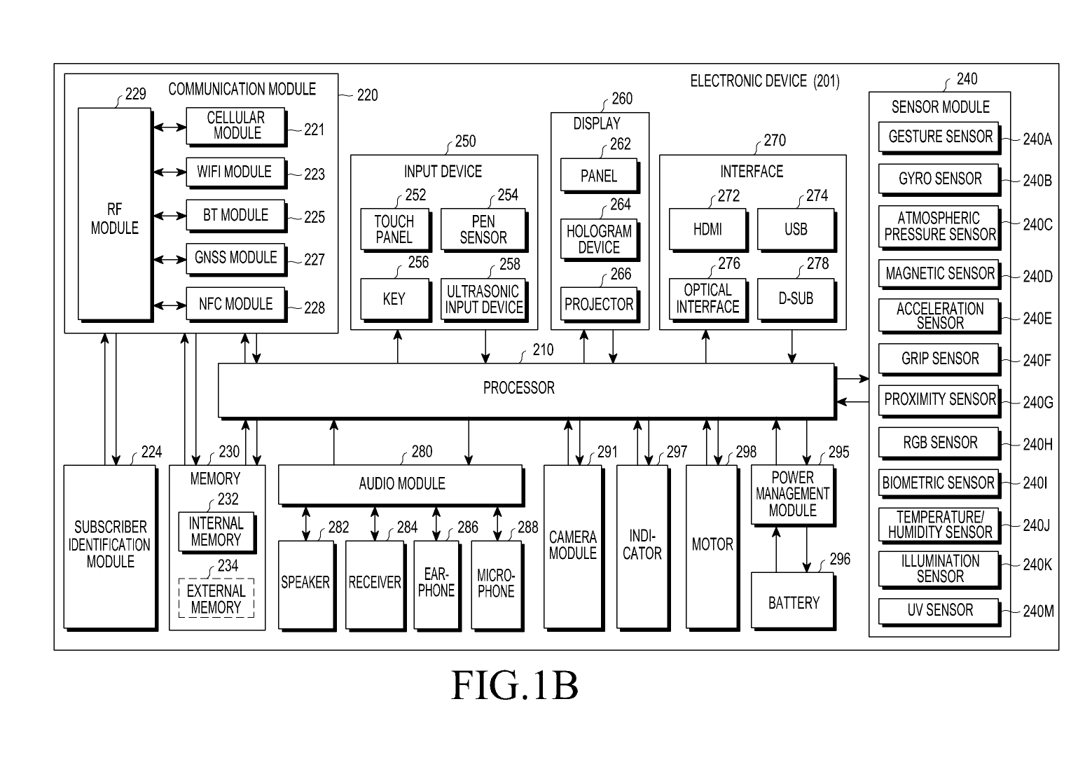

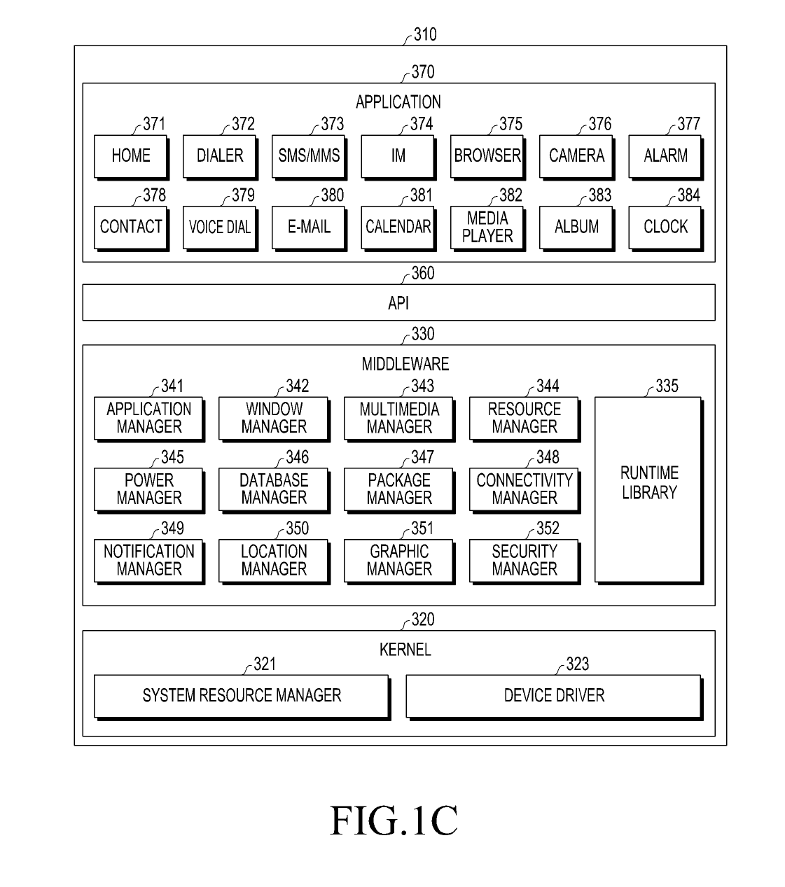

FIG. 1A illustrates a network configuration including an electronic device according to an embodiment of the present disclosure.

Referring to FIG. 1A, an electronic device 101 is included in a network environment 100. The electronic device 101 may include a bus 110, a processor 120, a memory 130, an input/output interface 150, a display 160, and a communication interface 170. In an embodiment of the present disclosure, the electronic device 101 may exclude at least one of the components or may add another component. The bus 110 may include a circuit for connecting the components 110 to 170 with one another and transferring communications (e.g., control messages or data) between the components. The processor 120 may include one or more of a CPU, an application processor (AP), a communication processor (CP), or the like. The processor 120 may perform control on at least one of the other components of the electronic device 101, and/or perform an operation or data processing relating to communication. The processor 120 executes a program 140 and controls the overall operation of the electronic device so that an application may quickly be executed, e.g., the length of a touch input on the electronic device according to an embodiment of the present disclosure as set forth below. The processor 120 may execute the program 140 to select an icon of an application displayed on, e.g., the touchscreen, of the display 160 or to run the application. There may be provided one or more processors 120. The processor 120 may also be referred to as a controller.

The memory 130 may include a volatile and/or non-volatile memory. For example, the memory 130 may store commands or data related to at least one other component of the electronic device 101. According to an embodiment of the present disclosure, the memory 130 may store software and/or a program 140. The program 140 may include, e.g., a kernel 141, middleware 143, an application programming interface (API) 145, and/or an application program (or “application”) 147. At least a portion of the kernel 141, middleware 143, or API 145 may be denoted an operating system (OS). For example, the kernel 141 may control or manage system resources (e.g., the bus 110, processor 120, or a memory 130) used to perform operations or functions implemented in other programs (e.g., the middleware 143, API 145, or application program 147). The kernel 141 may provide an interface that allows the middleware 143, the API 145, or the application 147 to access the individual components of the electronic device 101 to control or manage the system resources.

The middleware 143 may function as a relay to allow the API 145 or the application 147 to communicate data with the kernel 141, for example. Further, the middleware 143 may process one or more task requests received from the application program 147 in order of priority. For example, the middleware 143 may assign a priority of using system resources (e.g., the bus 110, the processor 120, or the memory 130) of the electronic device 101 to at least one of the application programs 147 and process one or more task requests. The API 145 is an interface allowing the application 147 to control functions provided from the kernel 141 or the middleware 143. For example, the API 133 may include at least one interface or function (e.g., a command) for filing control, window control, image processing or text control. For example, the input/output interface 150 may transfer commands or data input from the user or other external device to other component(s) of the electronic device 101 or may output commands or data received from other component(s) of the electronic device 101 to the user or other external devices.

The display 160 may include, e.g., a liquid crystal display (LCD), a light emitting diode (LED) display, an organic light emitting diode (OLED) display, or a microelectromechanical systems (MEMS) display, or an electronic paper display. The display 160 may display, e.g., various contents (e.g., text, images, videos, icons, or symbols) to the user. The display 160 may include a touchscreen and may receive, e.g., a touch, gesture, proximity or hovering input using an electronic pen or a body portion of the user. The display 160 may also referred to as a display panel.

For example, the communication interface 170 may set up communication between the electronic device 101 and an external electronic device (e.g., a first external electronic device 102, a second external electronic device 104, or a server 106). For example, the communication interface 170 may be connected with a wireless network 164 to the first external electronic device 102 and may also be connected with the network 162 through wireless or wired communication to communicate with the external electronic device (e.g., the second external electronic device 104 or the server 106).

The wireless communication may include cellular communication which uses at least one of, e.g., long term evolution (LTE), LTE-advanced (LTE-A), code division multiple access (CDMA), wideband CDMA (WCDMA), universal mobile telecommunication system (UNITS), wireless broadband (WiBro), or global system for mobile communication (GSM). According to an embodiment of the present disclosure, the wireless communication may include at least one of, e.g., Wi-Fi, Bluetooth (BT), Bluetooth low power (BLE), zigbee, near field communication (NFC), magnetic secure transmission (MST), radio frequency (RF), or body area network (BAN). According to an embodiment of the present disclosure, the wireless communication may include GNSS. The GNSS may be, e.g., global positioning system (GPS), global navigation satellite system (Glonass), Beidou navigation satellite system (hereinafter, “Beidou”) or Galileo, or the European global satellite-based navigation system. Hereinafter, the terms “GPS” and the “GNSS” may be interchangeably used herein. The wired connection may include at least one of, e.g., universal serial bus (USB), high definition multimedia interface (HDMI), recommended standard (RS)-232, power line communication (PLC), or plain old telephone service (POTS). The network 162 may include at least one of telecommunication networks, e.g., a computer network (e.g., local area network (LAN) or wide area network (WAN)), Internet, or a telephone network.

The first external electronic device 102 and the second external electronic device 104 each may be a device of the same or a different type from the electronic device 101. According to an embodiment of the present disclosure, all or some of operations executed on the electronic device 101 may be executed on another or multiple other electronic devices (e.g., the first external electronic device 102 and the second external electronic device 104 or the server 106). According to an embodiment of the present disclosure, when the electronic device 101 should perform some function or service automatically or at a request, the electronic device 101, instead of executing the function or service on its own or additionally, may request another device (e.g., the first external electronic device 102 and the second external electronic device 104 or the server 106) to perform at least some functions associated therewith. The other electronic device (e.g., the first external electronic device 102 and the second external electronic device 104 or the server 106) may execute the requested functions or additional functions and transfer a result of the execution to the electronic device 101. The electronic device 101 may provide a requested function or service by processing the received result as it is or additionally. To that end, a cloud computing, distributed computing, or client-server computing technique may be used, for example.

FIG. 1B illustrates a configuration of an electronic device according to an embodiment of the present disclosure.

Referring to FIG. 1B, the electronic device may include the whole or part of, e.g., the electronic device 101 shown in FIG. 1A. The electronic device of FIG. 1B may include one or more processors (e.g., application processors (APs)) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298. The processor 210 may control multiple hardware and software components connected to the processor 210 by running, e.g., an OS or application programs, and the processor 210 may process and compute various data. The processor 210 may be implemented in, e.g., a system on chip (SoC). According to an embodiment of the present disclosure, the processor 210 may further include a graphical processing unit (GPU) and/or an image signal processor. The processor 210 may include at least some (e.g., the cellular module 221) of the components shown in FIG. 1B. The processor 210 may load a command or data received from at least one of other components (e.g., a non-volatile memory) on a volatile memory, process the command or data, and store resultant data in the non-volatile memory.

The communication module 220 may have the same or similar configuration to the communication interface 170. The communication module 220 may include, e.g., a cellular module 221, a Wi-Fi module 223, a BT module 225, a GNSS module 227, a NFC module 228, and a RF module 229. The cellular module 221 may provide voice call, video call, text, or Internet services through, e.g., a communication network. According to an embodiment of the present disclosure, the cellular module 221 may perform identification or authentication on an electronic device 201 in the communication network using a subscriber identification module 224 (e.g., the SIM card). According to an embodiment of the present disclosure, the cellular module 221 may perform at least some of the functions providable by the processor 210. According to an embodiment of the present disclosure, the cellular module 221 may include a communication processor (CP). According to an embodiment of the present disclosure, at least some (e.g., two or more) of the cellular module 221, the Wi-Fi module 223, the Bluetooth module 225, the GNSS module 227, or the NFC module 228 may be included in a single integrated circuit (IC) or an IC package. The RF module 229 may communicate data, e.g., communication signals (e.g., RF signals). The RF module 229 may include, e.g., a transceiver, a power amp module (PAM), a frequency filter, a low noise amplifier (LNA), or an antenna. According to an embodiment of the present disclosure, at least one of the cellular module 221, the Wi-Fi module 223, the BT module 225, the GNSS module 227, or the NFC module 228 may communicate RF signals through a separate RF module. The subscription identification module 224 may include, e.g., a card including a subscriber identification module, or an embedded SIM, and may contain unique identification information (e.g., an integrated circuit card identifier (ICCID) or subscriber information (e.g., an international mobile subscriber identity (IMSI)).

The memory 230 (e.g., the memory 130) may include, e.g., an internal memory 232 or an external memory 234. The internal memory 232 may include at least one of, e.g., a volatile memory (e.g., a dynamic random access memory (DRAM), a static RAM (SRAM), a synchronous dynamic RAM (SDRAM), and the like) or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD). The external memory 234 may include a flash drive, e.g., a compact flash (CF) memory, a secure digital (SD) memory, a micro-SD memory, a min-SD memory, an extreme digital (xD) memory, a multi-media card (MMC), or a Memory Stick™. The external memory 234 may be functionally or physically connected with the electronic device 201 via various interfaces.

For example, the sensor module 240 may measure a physical quantity or detect a motion state of the electronic device 201, and the sensor module 240 may convert the measured or detected information into an electrical signal. The sensor module 240 may include at least one of, e.g., a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red-green-blue (RGB) sensor, a bio sensor 240I, a temperature/humidity sensor 240J, an illumination sensor 240K, or an ultra violet (UV) sensor 240M. Additionally or alternatively, the detection module 240 may include, e.g., an e-nose sensor, an electromyography (EMG) sensor, an electroencephalogram (EEG) sensor, an electrocardiogram (ECG) sensor, an infrared (IR) sensor, an iris sensor, or a finger print sensor. The sensor module 240 may further include a control circuit for controlling at least one or more of the sensors included in the detection module. According to an embodiment of the present disclosure, the electronic device 201 may further include a processor configured to control the sensor module 240 as part of the processor 210 or separately from the processor 210, and the electronic device 2701 may control the sensor module 240 while the processor 1210 is in a sleep mode.

The input unit 250 may include, e.g., a touch panel 252, a (digital) pen sensor 254, a key 256, or an ultrasonic input device 258. The touch panel 252 may use at least one of capacitive, resistive, infrared, or ultrasonic methods. The touch panel 252 may further include a control circuit. The touch panel 252 may further include a tactile layer and may provide a user with a tactile reaction. The (digital) pen sensor 254 may include, e.g., a part of a touch panel or a separate sheet for recognition. The key 256 may include e.g., a physical button, optical key or key pad. The ultrasonic input device 258 may detect an ultrasonic wave generated from an input tool through a microphone (e.g., a microphone 288) to identify data corresponding to the detected ultrasonic wave.

The display 260 (e.g., the display 160) may include a panel 262, a hologram device 264, a projector 266, and/or a control circuit for controlling the same. The panel 262 may be implemented to be flexible, transparent, or wearable. The panel 262, together with the touch panel 252, may be configured in one or more modules. According to an embodiment of the present disclosure, the panel 262 may include a pressure sensor (or pose sensor) that may measure the strength of a pressure by the user's touch. The pressure sensor may be implemented in a single body with the touch panel 252 or may be implemented in one or more sensors separate from the touch panel 252. The hologram device 264 may make three dimensional (3D) images (holograms) in the air by using light interference. The projector 266 may display an image by projecting light onto a screen. The screen may be, for example, located inside or outside of the electronic device 201. The interface 270 may include e.g., an HDMI 272, a USB 274, an optical interface 276, or a D-subminiature (D-sub) 278. The interface 270 may be included in e.g., the communication interface 170 shown in FIG. 1A. Additionally or alternatively, the interface 270 may include a mobile high-definition link (MHL) interface, a SD card/MMC interface, or infrared data association (IrDA) standard interface.

The audio module 280 may converting, e.g., a sound signal into an electrical signal and vice versa. At least part of the audio module 280 may be included in e.g., the input/output interface 145 as shown in FIG. 1A. The audio module 280 may process sound information input or output through e.g., a speaker 282, a receiver 284, an earphone 286, or a microphone 288. For example, the camera module 291 may be a device for capturing still images and videos, and may include, according to an embodiment of the present disclosure, one or more image sensors (e.g., front and back sensors), a lens, an image signal processor (ISP), or a flash, such as an LED or xenon lamp. The power manager module 295 may manage power of the electronic device 201, for example. According to an embodiment of the present disclosure, the power manager module 295 may include a power management Integrated circuit (PMIC), a charger IC, or a battery or fuel gauge. The PMIC may have a wired and/or wireless recharging scheme. The wireless charging scheme may include e.g., a magnetic resonance scheme, a magnetic induction scheme, or an electromagnetic wave based scheme, and an additional circuit, such as a coil loop, a resonance circuit, a rectifier, or the like may be added for wireless charging. The battery gauge may measure an amount of remaining power of the battery 296, a voltage, a current, or a temperature while the battery 296 is being charged. The battery 296 may include, e.g., a rechargeable battery or a solar battery.

The indicator 297 may indicate a particular state of the electronic device 201 or a part (e.g., the processor 210) of the electronic device, including e.g., a booting state, a message state, or recharging state. The motor 298 may convert an electric signal to a mechanical vibration and may generate a vibrational or haptic effect. The electronic device 201 may include a mobile TV supporting device (e.g., a GPU) that may process media data, e.g., digital multimedia broadcasting (DMB), digital video broadcasting (DVB), or mediaFlo™ standards. Each of the aforementioned components of the electronic device may include one or more parts, and a name of the part may vary with a type of the electronic device. According to various embodiments of the present disclosure, the electronic device (e.g., the electronic device 201) may exclude some elements or include more elements, or some of the elements may be combined into a single entity that may perform the same function as by the elements before combined.

FIG. 1C illustrates a configuration of a program module according to an embodiment of the present disclosure.

Referring to FIG. 1C, a program module 310 (e.g., the program 140) may include an OS controlling resources related to the electronic device (e.g., the electronic device 101) and/or various applications (e.g., the application processor 147) driven on the OS. The OS may include, e.g., Android™, iOS™, Windows™, Symbian™ Tizen™, or Bada™. Referring to FIG. 1C, the program module 310 may include a kernel 320 (e.g., the kernel 141), middleware 330 (e.g., the middleware 143), an API 360 (e.g., the API 145), and/or an application 370 (e.g., the application program 147). At least a part of the program module 310 may be preloaded on the electronic device or may be downloaded from an external electronic device (e.g., the first external electronic device 102 and the second external electronic device 104 or the server 106).

The kernel 320 may include, e.g., a system resource manager 321 or a device driver 323. The system resource manager 321 may perform control, allocation, or recovery of system resources. According to an embodiment of the present disclosure, the system resource manager 321 may include a process managing unit, a memory managing unit, or a file system managing unit. The device driver 323 may include, e.g., a display driver, a camera driver, a Bluetooth driver, a shared memory driver, a USB driver, a keypad driver, a Wi-Fi driver, an audio driver, or an inter-process communication (IPC) driver. The middleware 330 may provide various functions to the application 370 through the API 360 so that the application 370 may use limited system resources in the electronic device or provide functions jointly required by applications 370. According to an embodiment of the present disclosure, the middleware 330 may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, or a security manager 352.

The runtime library 335 may include a library module used by a compiler in order to add a new function through a programming language while, e.g., the application 370 is being executed. The runtime library 335 may perform input/output management, memory management, or arithmetic function processing. The application manager 341 may manage the life cycle of, e.g., the applications 370. The window manager 342 may manage GUI resources used on the screen. The multimedia manager 343 may grasp formats necessary to play media files and use a codec appropriate for a format to perform encoding or decoding on media files. The resource manager 344 may manage the source code or memory space of the application 370. The power manager 345 may manage, e.g., the battery capability or power and provide power information necessary for the operation of the electronic device. According to an embodiment of the present disclosure, the power manager 345 may interwork with a basic input/output system (BIOS). The database manager 346 may generate, search, or vary a database to be used in the applications 370. The package manager 347 may manage installation or update of an application that is distributed in the form of a package file.

The connectivity manager 348 may manage, e.g., wireless connectivity. The notification manager 349 may provide an event, e.g., arrival message, appointment, or proximity alert, to the user. The location manager 350 may manage, e.g., locational information on the electronic device. The graphic manager 351 may manage, e.g., graphic effects to be offered to the user and their related user interface. The security manager 352 may provide system security or user authentication, for example. According to an embodiment of the present disclosure, the middleware 330 may include a telephony manager for managing the voice or video call function of the electronic device or a middleware module able to form a combination of the functions of the above-described elements. According to an embodiment of the present disclosure, the middleware 330 may provide a module specified according to the type of the OS. Further, the middleware 330 may dynamically omit some existing components or add new components. The API 360 may be a set of, e.g., API programming functions and may have different configurations depending on OSs. For example, in the case of Android or iOS, one API set may be provided per platform, and in the case of Tizen, two or more API sets may be offered per platform.

The application 370 may include an application that may provide, e.g., a home application 371, a dialer application 372, an SMS/MMS application 373, an instant message (IM) application 374, a browser application 375, a camera application 376, an alarm application 377, a contact application 378, a voice dial application 379, an email application 380, a calendar application 381, a media player application 382, an album application 383, or a clock application 384, a health-care (e.g., measuring the degree of workout or blood sugar), or provision of environmental information (e.g., provision of air pressure, moisture, or temperature information). According to an embodiment of the present disclosure, the application 370 may include an information exchanging application supporting information exchange between the electronic device and an external electronic device. Examples of the information exchange application may include, but is not limited to, a notification relay application for transferring specific information to the external electronic device, or a device management application for managing the external electronic device. For example, the notification relay application may transfer notification information generated by other application of the electronic device to the external electronic device or receive notification information from the external electronic device and provide the received notification information to the user. For example, the device management application may install, delete, or update a function (e.g., turn-on/turn-off the external electronic device (or some elements) or adjusting the brightness (or resolution) of the display) of the external electronic device communicating with the electronic device or an application operating on the external electronic device. According to an embodiment of the present disclosure, the application 370 may include an application (e.g., a health-care application of a mobile medical device) designated according to an attribute of the external electronic device. According to an embodiment of the present disclosure, the application 370 may include an application received from the external electronic device. At least a portion of the program module 310 may be implemented (e.g., executed) in software, firmware, hardware (e.g., the processor 210), or a combination of at least two or more thereof and may include a module, program, routine, command set, or process for performing one or more functions.

As used herein, the term “module” includes a unit configured in hardware, software, or firmware and may interchangeably be used with other terms, e.g., “logic,” “logic block,” “part,” or “circuit.” The module may be a single integral part or a minimum unit or part of performing one or more functions. The module may be implemented mechanically or electronically and may include, e.g., an application-specific integrated circuit (ASIC) chip, field-programmable gate arrays (FPGAs), or programmable logic device, that has been known or to be developed in the future as performing some operations. According to an embodiment of the present disclosure, at least a part of the device (e.g., modules or their functions) or method (e.g., operations) may be implemented as instructions stored in a computer-readable storage medium (e.g., the memory 130), e.g., in the form of a program module. The instructions, when executed by a processor (e.g., the processor 120), may enable the processor to carry out a corresponding function. The computer-readable medium may include, e.g., a hard disk, a floppy disc, a magnetic medium (e.g., a magnetic tape), an optical recording medium (e.g., a compact disc-read only memory (CD-ROM), a digital versatile disc (DVD), a magnetic-optical medium (e.g., a floptical disk), or an embedded memory. The instruction may include a code created by a compiler or a code executable by an interpreter. Modules or programming modules in accordance with various embodiments of the present disclosure may include at least one or more of the aforementioned components, omit some of them, or further include other additional components. According to various embodiments of the present disclosure, operations performed by modules, programs, or other components may be carried out sequentially, in parallel, repeatedly, or heuristically, or at least some operations may be executed in a different order or omitted, or other operations may be added.

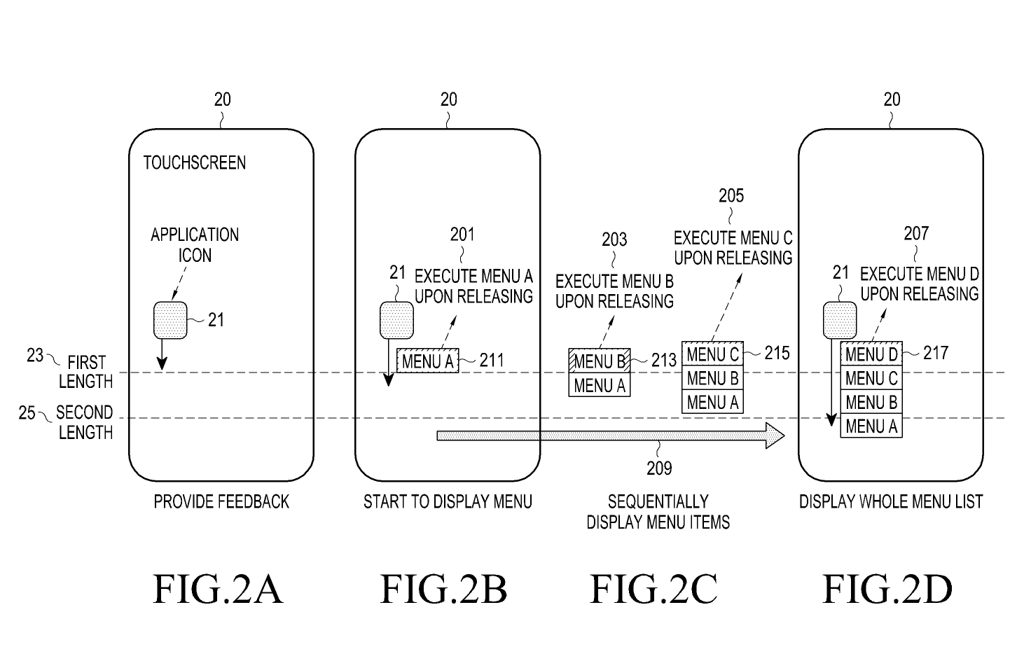

FIGS. 2A-2D illustrate operations of controlling execution of an electronic device, e.g., a length of a touch input on an electronic device according to an embodiment of the present disclosure.

Various embodiments for controlling the execution of an application are described below with examples of a (continuous) touch input(s) for ease of description. The length of the (continuous) touch input(s) is merely an example. Alternatively, execution of an application may also be controlled based on various factors related to the touch input(s), such as the speed, time, pressure, or area of the (continuous) touch input(s). The touch inputs may include direct touches using, e.g., a finger or stylus pen and indirect touches, such as hovering.

FIGS. 2A-2D illustrate example operations of providing feedback as to whether to be able to display a menu list including at least one menu items related to execution of an application when the user applies a touch input to an icon of the application, sequentially displaying menu items of the menu list where touch inputs with a predetermined length or more are continuously made, and executing the last menu item displayed in the menu list when the touch inputs are released.

Specifically, FIGS. 2A-2D illustrate one application icon 21 displayed on a touchscreen 20 for ease of description. However, multiple applications may be arranged according to an embodiment of the present disclosure.

Referring to FIG. 2A, the application icon 21 may include an icon area (e.g., a rectangular area as shown) where a touch input is sensible. When a touch input is applied within the icon area of the application icon 21 for a predetermined time (or predetermined sensitivity level or pressure) or more, the application may be executed. The application may also be executed by a continuous touch input according to an embodiment of the present disclosure.

FIGS. 2A-2D illustrate example operations when a continuous touch input with a predetermined length are moved by, e.g., a drag, with the touch input applied to the icon area of the application. In this case, a menu list may be displayed that includes one or more menu items related to the application. Each menu item may be at least one execution command that may be executed on the application, and the menu list may be a set of such one or more menu items. According to an embodiment of the present disclosure, at least one of the number or content of the menu items that may be shown in the menu list, e.g., the length of the continuous touch input may be varied depending on the length, speed, direction, pressure, or area of the continuous touch input.

The length of the continuous touch input may be set as the distance from the point (or area) where the first touch input has been applied within the icon area of the application to the last point (or area) of the continuous touch input. As the length of the continuous touch input, various distances that may represent how much the continuous touch input have moved may be used. One or more lengths may be set for the continuous touch input. The menu item related to the execution of the application may sequentially be provided or displayed, varied depending on the length of the continuous touch input. Various types of feedback for providing the menu item may be provided in a user interface. As the feedback, e.g., a blur, popup, or haptic effect, an effect sound or voice notification may be provided. The user may recognize the provision (or display) of the menu item through the feedback. The feedback may selectively be provided. The menu item may be displayed in the form of a menu list including one or more menu items. As used below in the disclosure, ‘display of menu item’ or ‘display of menu list’ may simply be denoted ‘menu display.’

According to an embodiment of the present disclosure, when the continuous touch input is released (e.g., when the continuous touch input is stopped, and the user's finger or stylus pen which made the continuous touch input are taken off, or rendered not to contact, the touchscreen), the operation of a menu item selected among multiple menu items of the application may be executed, e.g., the length of the continuous touch input.

Referring to FIGS. 2A-2D, the length of the continuous touch input is assumed to have a first length 23 and a second length 25 for ease of description. However, the present disclosure is not limited to two lengths of the continuous touch input. In the embodiment of FIG. 2B and FIG. 2C, where a continuous touch input of the first length 23 or more is made, the electronic device may sequentially display the menu items in the menu list. In the embodiment of FIG. 2D, where the continuous touch input is made up to the second length 25 at a predetermined speed or more (or within a predetermined time), the electronic device may simultaneously display all of the menu items related to the application.

The operations of the FIGS. 2A-2D embodiment are specifically described. When a touch input is applied by the user to an icon area (or its adjacent area) of an application icon 21 displayed on the touchscreen 20, and a continuous touch input are then applied up to the first length 23, feedback may be provided to indicate whether to provide (display) menu items related to execution of the application. The feedback may be provided as blurring the icons (not shown) of the other applications than the application icon 21, displaying a popup window indicating the provision of the menu item related to the execution of the application, or a vibration through a haptic device. When the continuous touch input continue to the first length or more after the feedback is provided, a first menu item 211 denoted as ‘menu A’ which can be executed on the application may first be displayed as shown in FIG. 2B. As an example, when the application is one for playing music, the application may include multiple selectable menu items, such as domestic music, foreign music, per-genre music, and per-chart music, and as the continuous touch input move, each of the multiple menu items may sequentially be displayed.

In the example of FIG. 2D, the menu items may be displayed by the continuous touch input in order, e.g., from menu A to menu D or in an order previously defined by the user. Alternatively, the order of display of the menu items, e.g., the continuous touch input may dynamically be varied depending on, e.g., the frequency of execution of the menu items. As still another example, after all of the menu items are displayed in the menu list by the continuous touch input, the number of menu items displayed may sequentially be reduced by a continuous touch input that is applied in a reverse direction of the continuous touch input. According to an embodiment of the present disclosure, the continuous touch input in the reverse direction are merely an example. For example, after all or some of the menu items are displayed, the number of the menu items displayed on the touchscreen may sequentially be reduced in the reverse order of the display of the continuous touch input in various manners, such as changing the direction of the continuous touch input. As such, various changes may be made to displaying the menu items.

Referring to FIG. 2B, when the user's continuous touch input is released with the first menu item 211 of the application displayed on an upper end of the menu list, the electronic device may execute menu A, which corresponds to the first menu item 211, on the application (201). When the continuous touch input continue, but rather than being released, with the first menu item 211 displayed, as indicated with reference number 209, menu B, which corresponds to a second menu item 213 among the multiple menu items in the menu list, may be displayed on an upper end of the menu list as a menu item executable when the continuous touch input is released, and menu C, which corresponds to a third menu item 215, may subsequently and sequentially be displayed on the upper end of the menu list as an executable menu item when the continuous touch input is released. In the example of the operation of sequentially displaying each menu item, e.g., the length of the continuous touch input of the application as shown in FIG. 2C, reference number 203 denotes executing menu B when the continuous touch input is released, and reference number 205 denotes executing menu C when the continuous touch input is released. Meanwhile, although an example in which the menu items executed when the continuous touch input is released are displayed on the upper end of the menu list, the menu items executed when the continuous touch input is released may be displayed in other various manners, e.g., displayed on a lower end of the menu list or displayed upside down or in a protruding pattern in any position.

According to an embodiment of the present disclosure, when the continuous touch input reach the second length 25 within a predetermined time or at a predetermined speed or more, all of the menu items 217 in the menu list of the application may simultaneously be display. When the user's continuous touch input is released or when all the menu items 217 are displayed by a touch input at a predetermined speed or more, the menu items are moved by a continuous touch input, such as a drag, and the continuous touch input is released, the menu item according to the movement may be executed, or the menu item selected by the second touch input after the release may be executed (207). Alternatively, when the continuous touch input reach the second length 25 within a predetermined time or at a predetermined speed or more, the menu item used most frequently for the application may immediately be executed, but rather than displaying (all) the menu items. The use frequency may be set dynamically by the electronic device's learning or through a user input.

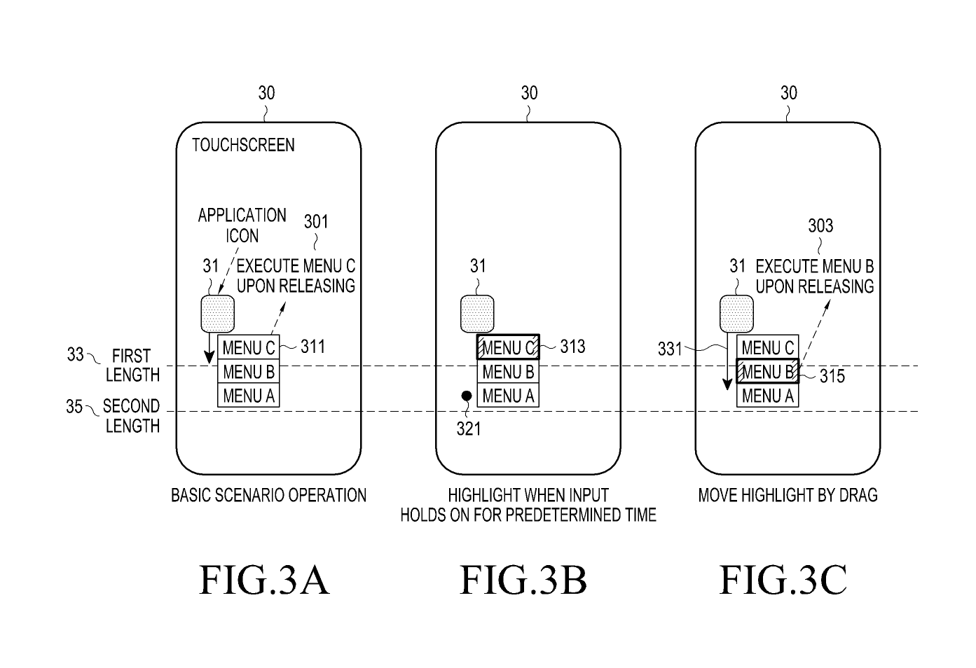

FIGS. 3A-3C illustrate operations of controlling execution of an electronic device, e.g., a length of a touch input on an electronic device according to an embodiment of the present disclosure.

Referring to FIGS. 3A-3C, one application icon 31 that is displayed on a touchscreen 30 for ease of description. The length of a continuous touch input is assumed to have two lengths, e.g., a first length 33 and a second length 35.

FIGS. 3A-3C illustrates an example in which, when the user's continuous touch input holds on for a predetermined time or a predetermined touch input is applied for a predetermined time or more in the basic scenario as in the examples of FIGS. 2A-2D, a menu item may visually be highlighted (e.g., to indicate the state of the touch input being not released) as in the examples of FIG. 3A and FIG. 3B, and the highlighting is moved to execute a desired menu item by the user's drag after the highlighting.

FIG. 3A illustrates an operation in the basic scenario as in the examples of FIGS. 2A-2D, wherein when the user's continuous touch input is released, with a menu item 311 selectable on the application displayed, the electronic device may execute menu C which corresponds to the first menu item 211 (301).

In another embodiment of the present disclosure, FIG. 3B illustrates a highlighting-activated state in which, when the user's touch input holds on or a predetermined touch input is applied for a predetermined time or more while displaying a menu item 313 executable upon releasing the continuous touch input, the display of the menu item 313 executable when released may be emphasized (and at this time, the touch input remains unreleased).

FIG. 3C illustrates an example of moving highlighting from the menu item 313 to a menu item 315 which is executable upon releasing by the user's drag after the highlighting, as denoted by reference number 331. Thereafter, when the touch input is released, menu B which corresponds to the menu item 315 may be executed, as denoted by reference number 303.

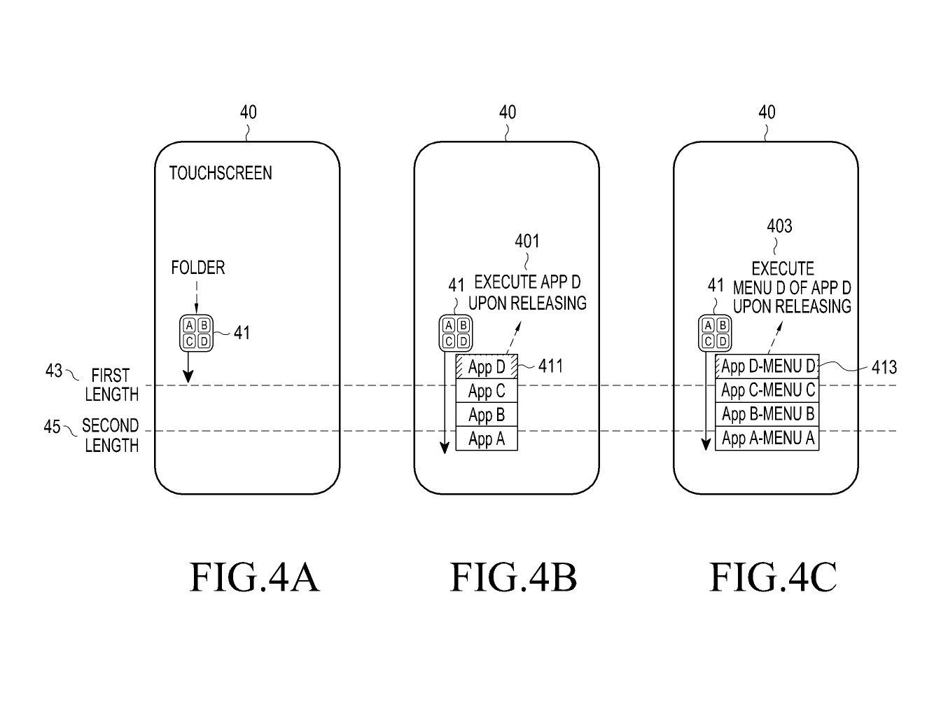

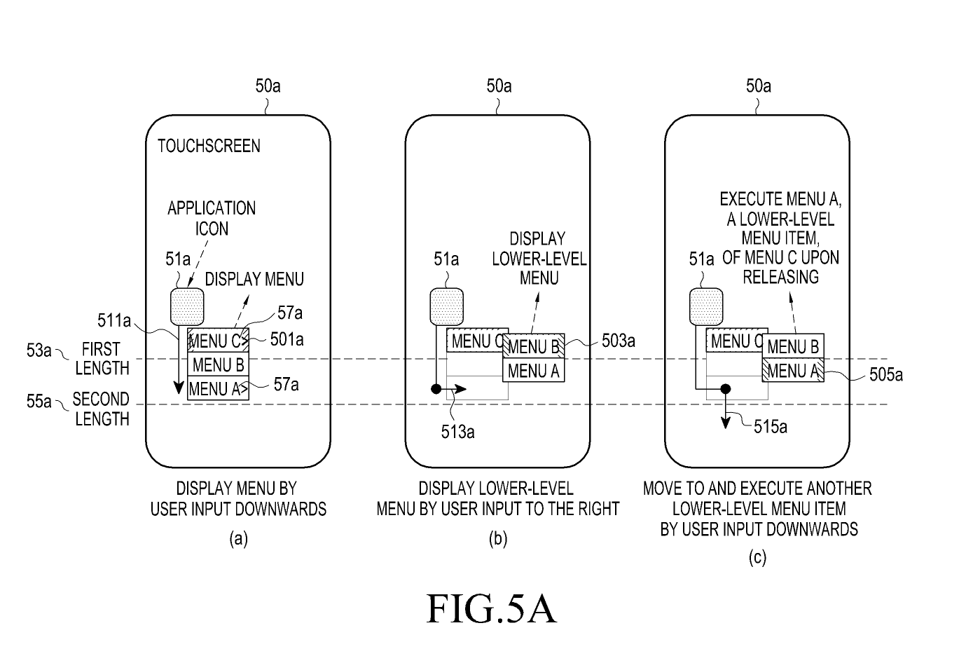

FIGS. 4A-4C illustrate operations of controlling execution of an application(s) included in a folder, e.g., a length of a touch input on an electronic device according to an embodiment of the present disclosure.

Referring to FIGS. 4A-4C, one folder icon 41 that is displayed on a touchscreen 40 for ease of description. The length of a continuous touch input is assumed to have two lengths, e.g., a first length 43 and a second length 45.

The basic operation described above in connection with the embodiment of FIGS. 2A-2D and a diversity variations thereto are applicable in the same manner as that of the embodiment of FIGS. 4A-4C. FIGS. 4A-4C illustrates operations in which a continuous touch input is applied to a folder icon 41 including a group of application(s), but not to an application icon.

FIG. 4A illustrates the operation of performing a continuous touch input after a first touch input is made to the folder icon 41. For example, when a touch input is applied by the user onto an icon area (or its adjacent area) of the folder icon 41 displayed on the touchscreen 40, followed by applying a continuous touch input up to the first length 43, feedback may be provided that indicates whether to provide (display) a menu item (e.g., a list of all or some of applications in the folder or both the list of all or some of the applications in the folder and at least one menu item for each application) including at least one menu item related to execution of the application(s) included in the folder. The list of some of the applications in the folder may dynamically set by, e.g., the frequency of use of the applications or may be set by the user's settings. When various embodiments of the present disclosure apply to the folder icon 41 as shown in FIGS. 4A-4C, each menu item may correspond to a respective one of the applications in the folder. In other words, the menu item for each application icon may correspond to at least one function executable on the application as in the embodiment of FIGS. 2A-2D, and the menu item for the folder icon including at least one application may correspond to each application for the folder icon as in the embodiment of FIGS. 4A-4C. As such, a menu item as used herein may be appreciated as corresponding to an application or a function of the application according to an embodiment of the present disclosure. A menu list may likewise be understood as a list of application functions or a list of applications according to an embodiment of the present disclosure.

Referring to FIG. 4B, upon detecting that the continuous touch input continue up to the first length 43 or more, the application(s) executable in the folder, e.g., from application D (App D) to application A (App A), may sequentially be displayed on an upper end of the menu item as menu items executable upon releasing the continuous touch input. When App D is displayed on the upper end of the menu item as an executable menu item 411, and the continuous touch input is released (401), the electronic device may execute App D. When the continuous touch input move and reach the second length 45, a menu list including all the menu items of all the applications in the folder may be displayed as in the example of FIG. 4B. FIG. 4C illustrates a variation to the embodiment of FIG. 4B, which shows an example of displaying the application executable on each menu item when the continuous touch input is released, along with the function executed on the application. For example, where App D is executed as denoted with reference number 413 when App D is displayed on the upper end of the menu item as an executable menu item 411, and the continuous touch input is released (403), the function (menu D) of App D may immediately be executed. Here, the function immediately executed when the application is executed may be set dynamically by the frequency of use of each function or by the user's input. Alternatively, when the continuous touch input reach the second length 45 within a predetermined time or at a predetermined speed or more, a preset application in the folder or the function of the application may immediately be executed.

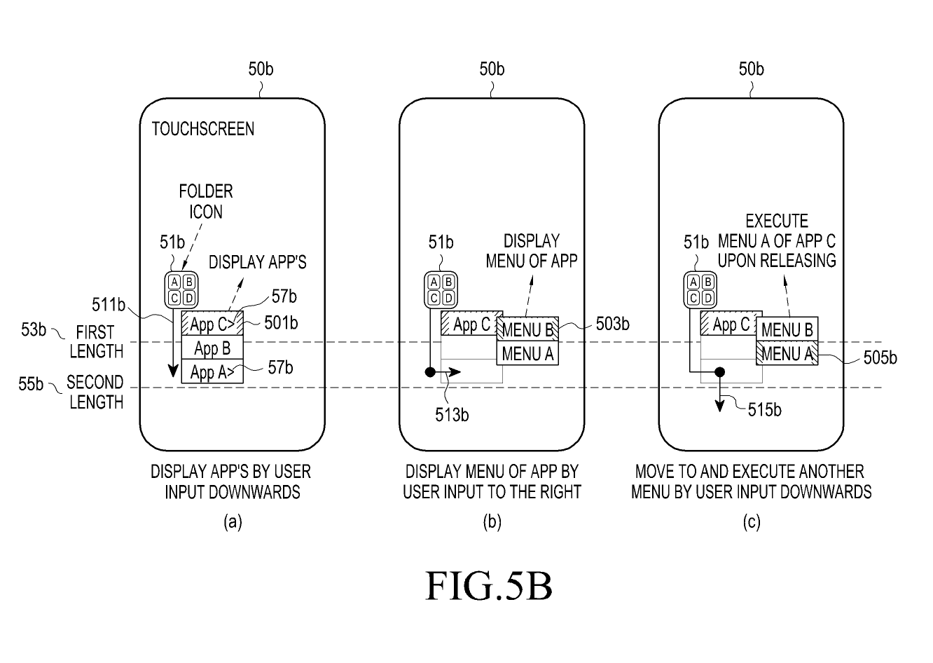

FIGS. 5A and 5A illustrate operations of controlling execution of an application, e.g., a length and redirection of a touch input on an electronic device according to an embodiment of the present disclosure. The basic operation described above in connection with the embodiment of FIGS. 2A-2D and 4A-4C and a diversity variations thereto are applicable in the same manner as that of the embodiments of FIGS. 5A and 5B.

Referring to FIGS. 5A and 5B, respectively, illustrate one application icon 51a and one folder icon 51b that are displayed on touchscreens 50a and 50b for ease of description. The length of a continuous touch input is assumed to have two lengths, e.g., a first length 53a or 53b and a second length 55a or 55b. FIG. 5A illustrates an example in which at least one upper-level menu item is displayed that is executable on the application, e.g., the length of a continuous touch input, and at least one lower-level menu item is displayed that is included in the upper-level menu item of the application as the continuous touch input changes its direction. FIG. 5B illustrates an example in which at least one application included in the folder is displayed as an upper-level menu item, e.g., the length of a continuous touch input, and at least one menu item executable on the application is displayed as a lower-level menu item as the continuous touch input changes its direction. In the embodiments of FIGS. 5A and 5B, the lower-level menu item may be present or absent depending on the function or configuration of the application. When a lower-level menu item is present, an identification symbol 57a or 57b may be displayed at a side of the menu item to indicate that the lower-level menu item is present as shown on the touchscreen 50a or 50b.

FIG. 5A(a) illustrates a basic scenario operation as in the examples of FIGS. 2A-2D. Upper-level menu items 501a may sequentially be displayed that are executable on the application, e.g., the length of the continuous touch input 511a. FIG. 5A(b) illustrates an example in which, when the direction of the continuous touch input 513a is changed to the right by a predetermined length (or more), at least one lower-level menu item (e.g., 503a) included in the upper-level menu item 501a is displayed. FIG. 5A(c) illustrates an example in which, when the direction of the continuous touch input 515a is changed downwards from the right by a predetermined length (or more), a change between menu items is rendered possible so that a desired lower-level menu item 505a may be selected among the at least one lower-level menu item (e.g., 503a). Thereafter, when the touch input is released off the lower-level menu item 505a, menu A may be executed. As in the above example, each lower-level menu item may include at least one selectable lower-level menu item. Each lower-level menu item may also include at least one selectable sub lower-level menu item.

FIG. 5B(a) illustrates a basic scenario operation as in the examples of FIGS. 4A-4C. At least one application that is executable in the folder, e.g., the length of a continuous touch input 511b may sequentially be displayed as upper-level menu item(s).

Referring to FIG. 5B(b), application A (App A) through application C (App C) that are executable in the folder may sequentially be displayed on an upper end of the menu item as menu items executable upon releasing the continuous touch input. When the direction of the continuous touch input is changed, e.g., to the right, by a predetermined length (or more) as denoted with reference number 513b in FIG. 5B(b) while App C is being displayed on the upper end of the menu item as the upper-level menu item 501b, at least one lower-level menu item (e.g., 503b), which is included in the upper-level menu item 501b, may be displayed. FIG. 5B(c) illustrates an example in which, when the direction of the continuous touch input 515b is changed downwards from the right by a predetermined length (or more), a change between menu items is rendered possible so that a desired lower-level menu item 505b may be selected among the at least one lower-level menu item (e.g., 503b). Thereafter, when the touch input is released off the lower-level menu item 505b, menu A may be executed.

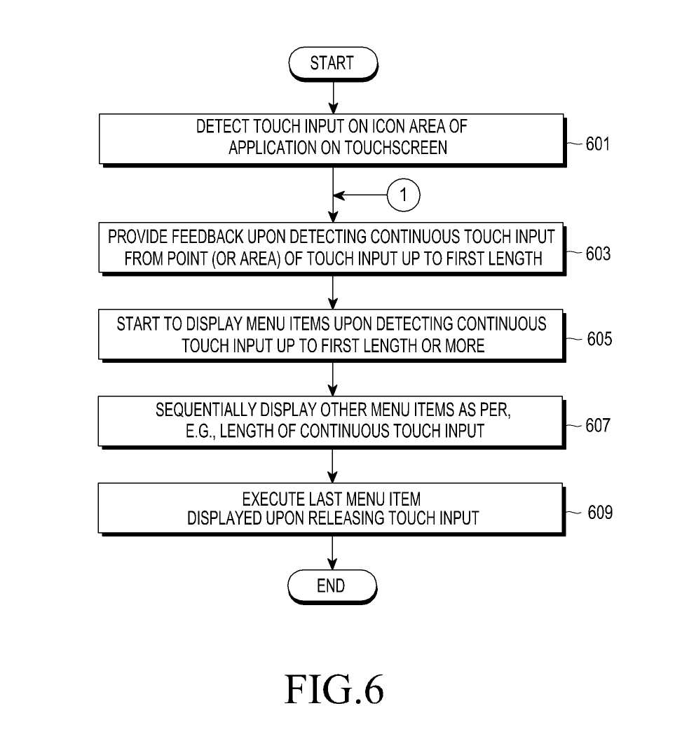

Various methods for controlling execution of an application are described below, e.g., the length of a touch input according to the present disclosure, with reference to FIGS. 6 to 10. It should be noted that the methods shown in FIGS. 6 to 10 are merely an example and that at least one combination or variation to the embodiments of FIGS. 2A to 5B are applicable to the methods of FIGS. 6 to 10.

FIG. 6 illustrates a method for controlling execution of an electronic device, e.g., a length of a touch input on an electronic device according to an embodiment of the present disclosure.

Referring to FIG. 6, an electronic device detects a touch input on an icon area of an application on a touchscreen in operation 601. Thereafter, in operation 603, upon detecting continuous touch input from the point (or area) of the touch input to a first length, the electronic device may provide feedback (e.g., blurring, a popup window, haptic, or sound) to indicate that it is an application icon displaying menu items through the display screen. In operation 603, the touch input area may be set in various forms, e.g., as a touched icon area or its adjacent area. In the following embodiment of the present disclosure, the touch input areas may be appreciated in the same meaning. Operation 603 may be selectively performed. In operation 605, upon detecting a continuous touch input of the first length or more, the electronic device may restart displaying the menu item related to the execution of the application. Thereafter, in operation 607, when the continuous touch input continue, other menu items executable on the application may sequentially be displayed, e.g., the length of the continuous touch input as in the various embodiments described above with reference to FIGS. 2 to 5B. Thereafter, in operation 609, when the user releases the touch input, the electronic device may execute the last menu item displayed.

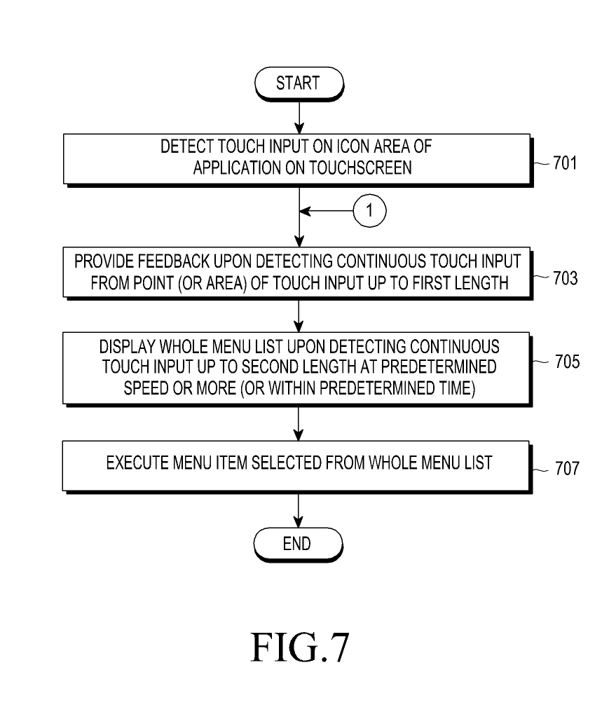

FIG. 7 illustrates a method for controlling execution of an electronic device, e.g., a length of a touch input on an electronic device according to an embodiment of the present disclosure.

Referring to FIG. 7, an electronic device may detect a touch input on an icon area of an application on a touchscreen in operation 701. Thereafter, in operation 703, upon detecting a continuous touch input from the point (or area) of the touch input to a first length, the electronic device may provide feedback (e.g., blurring, a popup window, haptic, or sound) to indicate that it is an application icon displaying menu items through the display screen. Operation 701 may be selectively performed. Then, in operation 705, upon detecting a continuous touch input up to a second length at a predetermined speed or more (or within a predetermined time), the electronic device may display all the menu items. In operation 707, the electronic device may execute a menu item selected from the whole menu list. In operation 705, the continuous touch input may be detected based on various references, such as the area or pressure of the touch, as well as the speed or time of the touch. In operation 707, the various methods described in connection with the above embodiments may be adopted to select a menu item. A touch input may also be possible to select the menu item. In operation 705, the continuous touch input in the predetermined speed or more may be detected in a range from the first length to the second length or in a range from the point (or area) of the first touch input as in operation 701 to the second length. As such, various ranges for detecting the continuous touch input in the predetermined speed or more may be provided. Accordingly, it may also be possible to display all the menu items upon detecting the continuous touch input at the predetermined speed or more while sequentially displaying at least one menu item by the method of FIG. 6.

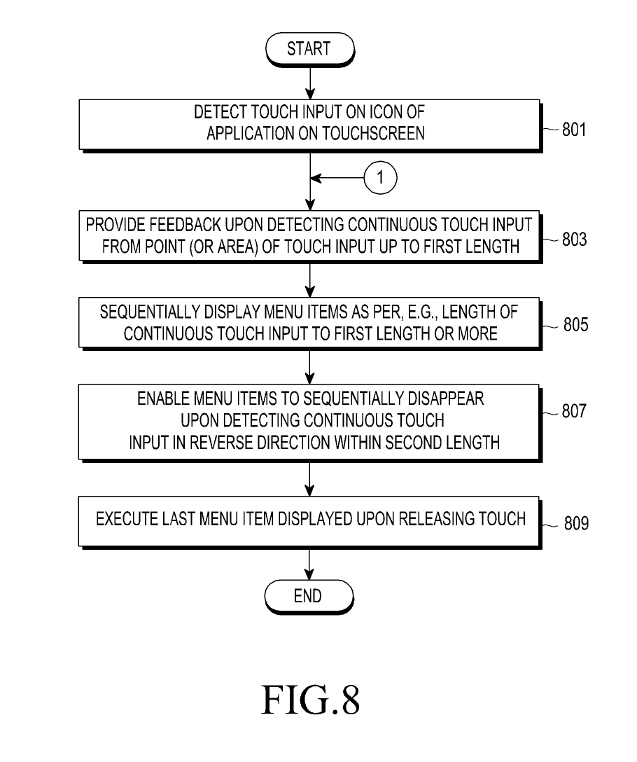

FIG. 8 illustrates a method for controlling execution of an electronic device, e.g., a length and direction of a touch input on an electronic device according to an embodiment of the present disclosure.

Referring to FIG. 8, an electronic device may detect a touch input on an icon area of an application on a touchscreen in operation 801. Thereafter, in operation 803, upon detecting a continuous touch input from the point (or area) of the touch input to a first length, the electronic device may provide feedback (e.g., blurring, a popup window, haptic, or sound) to indicate that it is an application icon displaying menu items through the display screen. Operation 803 may be selectively performed. In operation 805, upon detecting a continuous touch input of the first length or more, the electronic device may sequentially display at least one menu item executable on the application, e.g., the length of the continuous touch input. In operation 807, upon detecting a continuous touch input in the reverse direction within the second length, the electronic device may enable the displayed menu items to sequentially disappear, e.g., the length of the continuous touch input in the reverse direction. Thereafter, in operation 809, when the user releases the touch input while sequentially displaying the menu items, the electronic device may execute the last menu item displayed upon releasing the continuous touch input.

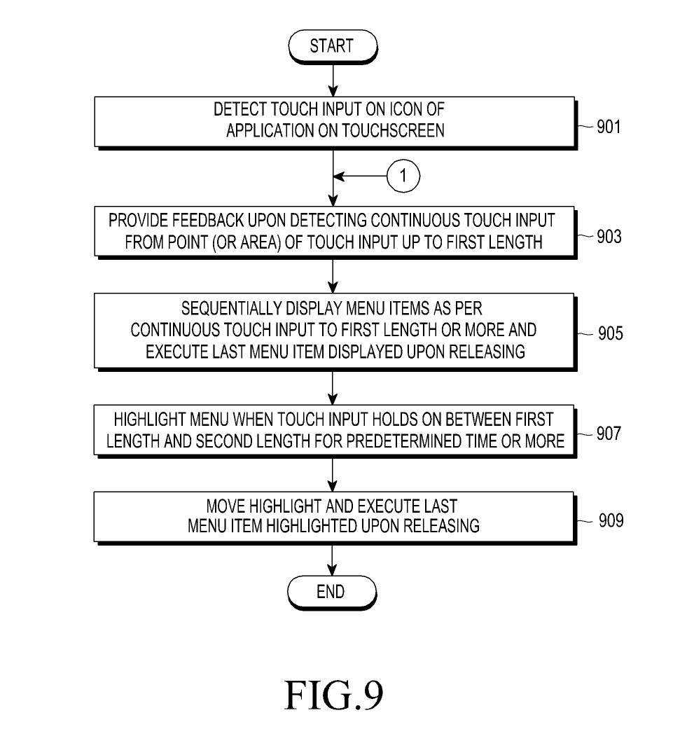

FIG. 9 illustrates a method for controlling execution of an electronic device, e.g., a length and time of a touch input on an electronic device according to an embodiment of the present disclosure.

Referring to FIG. 9, an electronic device may detect a touch input on an icon area of an application on a touchscreen in operation 901. Thereafter, in operation 903, upon detecting a continuous touch input from the point (or area) of the touch input to a first length, the electronic device may provide feedback (e.g., blurring, a popup window, haptic, or sound) to indicate that it is an application icon displaying menu items through the display screen. Operation 903 may be selectively performed. In operation 905, upon detecting a continuous touch input of the first length or more, the electronic device may sequentially display at least one menu item executable on the application, e.g., the length of the continuous touch input. At this time, the electronic device may execute the last menu item displayed upon releasing the continuous touch input. In operation 907, where the user's continuous touch input hold on between the first length and the second length for a predetermined time without being released in operation 905, the menu item may be highlighted as in the embodiment of FIG. 3. Thereafter, in operation 909, when the user releases the touch input after moving the highlight between menu items, the electronic device may execute the last menu item highlighted upon releasing the touch input.

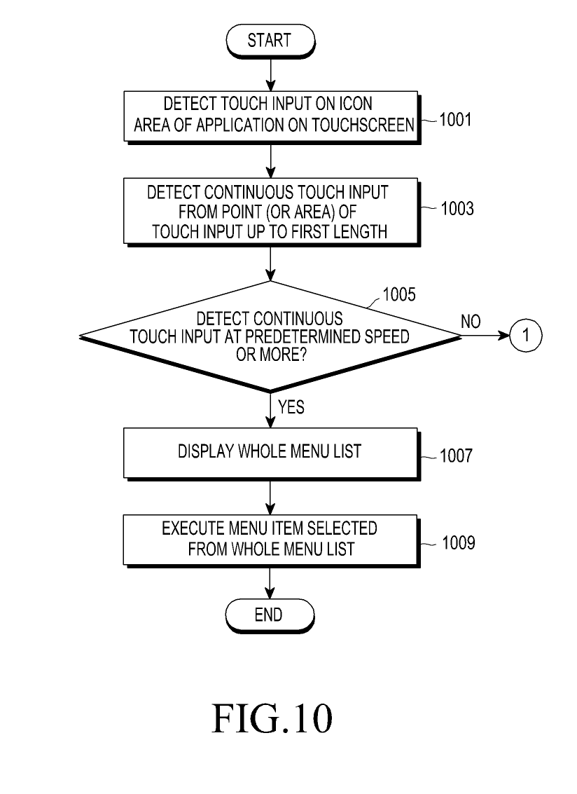

FIG. 10 illustrates a method for controlling execution of an electronic device, e.g., a length and speed of a touch input on an electronic device according to an embodiment of the present disclosure.

Referring to FIG. 10, an electronic device may detect a touch input on an icon area of an application on a touchscreen in operation 1001. Thereafter, in operation 1003, upon detecting a continuous touch input from the point (or area) of the touch input to a first length, when the continuous touch input continue, the electronic device may determine whether the continuous touch input reach a second length within a predetermined time or at a predetermined speed or more in operation 1005. Where the continuous touch input reach the second length at the predetermined speed or more (or within the predetermined time) in operation 1005, the electronic device may display the whole menu list in operation 1007. Thereafter, in operation 1009, the electronic device may execute a menu item selected from the whole menu list.

Unless the continuous touch input reach the second length at the predetermined speed or more or within the predetermined time in operation 1005, the electronic device may perform operation 603, 703, 803, or 903 and its subsequent operations as in the embodiments of FIGS. 6 to 9, executing the menu item, e.g., the length of the continuous touch input.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

According to the embodiments of the present disclosure, a function of an application may be executed or accessed by, e.g., one touch input, enhancing user convenience. Further, a function of an application may quickly be executed or accessed, saving the time for entry and current consumption.

According to an embodiment of the present disclosure, in an example of a configuration, a method for controlling execution of an application on an electronic device using a touchscreen may comprise detecting a touch input on an icon area of the application displayed on the touchscreen, displaying at least one menu item corresponding to at least one function of the application based on a continuous touch input after detecting the touch input, and controlling the execution of the application based on the at least one menu item.

According to an embodiment of the present disclosure, in an example of a configuration, an electronic device using a touchscreen may comprise a housing, a display panel including the touchscreen, a memory storing a program for controlling execution of an application, and a controller controlling detecting a touch input on an icon area of the application displayed on the touchscreen, displaying at least one menu item corresponding to at least one function of the application based on a continuous touch input after detecting the touch input, and controlling the execution of the application based on the at least one menu item.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling execution of an application on an electronic device using a touchscreen, the method comprising:
detecting a touch input on an icon area of the application displayed on the touchscreen;
displaying at least one menu item corresponding to at least one function of the application based on a continuous touch input after detecting the touch input; and
controlling the execution of the application based on the at least one menu item.

2. The method of claim 1, further comprising providing feedback to indicate whether to display the at least one menu item through a user interface of the electronic device upon detecting the continuous touch input up to a first length.

3. The method of claim 2, wherein the feedback includes at least one of blurring, a popup window, a haptic, an effect sound, or a voice notification.

4. The method of claim 1, further comprising at least one of:
sequentially displaying the at least one menu item when a length of the continuous touch input is a first length or more; or
displaying all menu items corresponding to functions of the application when the continuous touch input reaches a second length at a predetermined speed or more or within a predetermined time.

5. The method of claim 1, further comprising:
displaying a lower-level menu item of the application upon detecting redirecting the continuous touch input, or
excluding at least one displayed menu item from a menu list upon detecting reversely redirecting the continuous touch input, or
highlighting the at least one menu item when the continuous touch input holds on for a predetermined time or more.

6. The method of claim 1, wherein the controlling of the execution of the application includes at least one of:
executing a last menu item displayed among the at least one menu item upon releasing the continuous touch input, or
executing a menu item selected from among all the menu items.

7. The method of claim 1, wherein the icon area includes an area of a folder icon where a group of applications belong.

8. The method of claim 7, wherein each of the at least one menu item includes at least one of an application item as an upper-level menu item or a menu item corresponding to a function of the application as a lower-level menu item.

9. The method of claim 1, wherein at least one of the touch input or the continuous touch input includes at least one of a direct touch or an indirect touch.

10. The method of claim 1, wherein the at least one menu item is displayed based on at least one of a length, speed, time, pressure, or area of the continuous touch input.

11. An electronic device using a touchscreen, the electronic device comprising:
a housing;
a display panel including the touchscreen;
a memory configured to store a program for controlling execution of an application; and
at least one processor configured to:
control detection of a touch input on an icon area of the application displayed on the touchscreen,
control displaying of at least one menu item corresponding to at least one function of the application based on a continuous touch input after detecting the touch input, and
control the execution of the application based on the at least one menu item.

12. The electronic device of claim 11, wherein the at least one processor is further configured to control providing of feedback to indicate whether to display the at least one menu item through a user interface of the electronic device upon detecting the continuous touch input up to a first length.

13. The electronic device of claim 12, wherein the feedback includes at least one of blurring, a popup window, a haptic, an effect sound, or a voice notification.

14. The electronic device of claim 11, wherein the at least one processor is further configured to:
control sequentially displaying the at least one menu item when a length of the continuous touch input is a first length, and
control displaying of all menu items corresponding to functions of the application when the continuous touch input reaches a second length at a predetermined speed or more or within a predetermined time.

15. The electronic device of claim 11, wherein the at least one processor is further configured to:
control displaying of a lower-level menu item of the application upon detecting redirecting the continuous touch input, or
control excluding of at least one displayed menu item from a menu list upon detecting reversely redirecting the continuous touch input, or
control highlighting of the at least one menu item when the continuous touch input holds on for a predetermined time or more.

16. The electronic device of claim 11, wherein the at least one processor is further configured to:
control executing of a last menu item displayed among the at least one menu item upon releasing the continuous touch input, or
control executing of a menu item selected from among all the menu items.

17. The electronic device of claim 11, wherein the icon area includes an area of a folder icon where a group of applications belong.

18. The electronic device of claim 17, wherein each of the at least one menu item includes at least one of an application item as an upper-level menu item or a menu item corresponding to a function of the application as a lower-level menu item.

19. The electronic device of claim 11, wherein at least one of the touch input or the continuous touch input includes at least one of a direct touch or an indirect touch.

20. The electronic device of claim 11, wherein the at least one menu item is displayed based on at least one of a length, speed, time, pressure, or area of the continuous touch input.
